(19) United States
(12) Patent Application Publication
(10) Pub. No.: US 2009/0289030 A1
(43) Pub. Date: Nov. 26, 2009

(54) METHOD OF FABRICATING PRINTED WIRING BOARD

(76) Inventor: Yukihiro UENO, Hiroshima (JP)

Correspondence Address: BIRCH STEWART KOLASCH & BIRCH, PO BOX 747, FALLS CHURCH, VA, 22040-0747, US

(21) Appl. No.: 12/396,790

(22) Filed: Mar. 3, 2009

(30) Foreign Application Priority Data
May 22, 2008 (JP) 2008-134113

(51) Int. Cl. H01B 13/00

(52) U.S. Cl. 216/17

(57) ABSTRACT

A method of fabricating a printed wiring board that is capable of forming a minute via hole with high accuracy is provided. This method of fabricating a printed wiring board 1 comprises: a step of forming an insulation resin layer on at least one surface side of a core wiring board; a step of forming a first resist layer on a predetermined region of a surface of the insulation resin layer; a step of forming a first metal layer with a plating method on a region of the surface of the insulation resin layer except the region where the first resist layer is formed; and a step of forming a via hole by laser machining using the first metal layer as a mask.

This application is based on Japanese Patent Application No. 2008-134113 filed on May 22, 2008, the contents of which are hereby incorporated by reference.

### BACKGROUND OF THE INVENTION

1. Field of the Invention

The present invention relates to a method of fabricating a printed wiring board, and more particularly, to a method of fabricating a printed wiring board which forms a via hole by laser machining.

2. Description of Related Art

Conventionally, a method of fabricating a printed wiring board which forms a via hole by laser machining is known.

FIG. 12 is a sectional view showing a structure of a printed wiring board as a conventional example in which a via hole is formed. FIG. 13 is a sectional view of a structure of a core wiring board of the printed wiring board as the conventional example shown in FIG. 12. FIGS. 14 to 18 are sectional views to explain a method of fabricating the printed wiring board as the conventional example shown in FIG. 12.

As shown in FIG. 12, a printed wiring board 101 as the conventional example is composed of a core wiring board 110 that includes conductor circuit patterns 112 formed on both surfaces (on upper and lower surfaces) of an insulation layer 111, insulation resin layers 102 formed on both surfaces of the core wiring board 110, and conductor circuit patterns 103 formed on surfaces of the insulation resin layers 102.

The insulation layer 111 of the core wiring board 110 is formed of an insulation resin and the like. The conductor circuit pattern 112 is formed of copper foil and the like.

As shown in FIG. 13, a through hole 11 la is formed through the insulation layer 111. The conductor circuit pattern 112 on the upper surface of the insulation layer 111, and the conductor circuit pattern 112 on the lower surface of the insulation layer 111 are electrically connected to each other by this through hole 111a. A filling material 113 formed of a conductor or a dielectric is filled in the conductor circuit pattern 112 at the through hole 111a.

As shown in FIG. 12, the conductor circuit patterns 103 are composed of copper-foil patterns 104 formed on surfaces (on upper and lower surfaces) of the insulation resin layers 102, and plated patterns 105 formed on surfaces of the copper-foil patterns 104.

A via hole 120 is formed on a predetermined region of the printed wiring board 101, and the plated pattern 105 is so formed as to cover the inner surface of the via hole 120. Thus, the copper-foil pattern 104 (the conductor circuit pattern 103) formed on the outer side of the insulation resin layer 102, and the conductor circuit pattern 112 formed on the inner side of the insulation resin layer 102 are electrically connected to each other.

Next, a method of fabricating the printed wiring board 101 as the conventional example is explained. First, as shown in FIG. 13, the core wiring board 110 composed of the conductor circuit patterns 112 that are formed on both surfaces of the insulation layer 111 is prepared.

And, as shown in FIG. 14, a copper foil 104a is laminated and bonded on both surfaces of the core wiring board 110 with the insulation resin layer 102 interposed therebetween.

Then, a resist layer 130 (see FIG. 15) is formed on a predetermined region (on a region except the region of the copper foil 104a where the via hole 120 is formed) of the surface of the copper foil 104a. And, part (the region of the copper foil 104a where the via hole 120 is to be formed) of the copper foil 104a is etched by using the resist layer 130 (see FIG. 15) as a mask. Thus, as shown in FIG. 15, a hole portion 104b is formed through the copper foil 104a. Then, the resist layer 130 is removed.

Next as shown in FIG. 16, laser machining is carried out using the copper foil 104a as a mask to remove the insulation resin layer 102 under the hole portion 104b of the copper foil 104a until part of the conductor circuit pattern 112 is exposed. Thus, the via hole 120 is formed on the printed wiring board 101. Such method of forming a via hole is called a conformal method, and is disclosed, for example, in JP-A-1983-64097 and JP-A-1988-224390.

Then, as shown in FIG. 17, plated layers 105a are formed on surfaces (on upper and lower surfaces) of the copper foil 104a by performing panel plating. Here, the plated layer 105a is also formed on the inner surface of the via hole 120. The panel plating is a technique to form a constant-thick plated layer by using electroless plating, or electrolytic plating, or both of them.

Then, a resist layer (not shown) is formed on a predetermined region of the surface of the plated layer 105a, and parts of the plated layer 105a and of the copper foil 104a are etched using the resist layer (not shown) as a mask. Thus, the conductor circuit pattern 103 (see FIG. 12) composed of the copper-foil pattern 104 and the plated pattern 105 is formed. And, the resist layer (not shown) is removed, thereby the printed wiring board 101 shown in FIG. 12 is obtained.

In the method of fabricating the printed wiring board 101 as the conventional example described above, because the copper foil 104a is laminated and bonded on the core wiring board 110 with the insulation resin layer 102 interposed therebetween, the copper foil 104a needs to have a predetermined thickness, and cannot be made thin excessively. Accordingly, the copper foil 104a usually has a thickness of about 18 μm to about 50 μm.

However, to form the hole portion 104b through the copper foil 104a by etching, usually, the inner diameter of the hole portion 104b is required to be several times as large as the thickness of the copper foil 104a. Besides, because the copper foil 104a has a thickness of about 18 μm to about 50 μm, the cross section of the hole portion 104b formed by etching has a mortar shape because of a side etching effect as shown in FIG. 18. In other words, the shape and inner diameter of the hole portion 104b do not agree with the shape and inner diameter of the hole portion 130a of the resist layer 130, which is unstable.

Accordingly, in forming the via hole 120, if the copper foil 104a through which the hole portion 104b is formed is used as a mask, there is a problem that it is hard to form the minute via hole 120 having the inner diameter of dozens of micrometers with high accuracy.

### SUMMARY OF THE INVENTION

The present invention has been made to cope with the conventional problems, and it is an object of the present invention to provide a method of fabricating a printed wiring board that is capable of forming a minute via hole with high accuracy.

To achieve the object, a method of fabricating a printed wiring board according to a first aspect of the present invention comprises: a step of preparing a core wiring board composed of a first conductor circuit pattern that is formed on at least one surface of an insulation layer; a step of forming an insulation resin layer on at least one surface side of the core wiring board to cover the first conductor circuit pattern; a step of forming a first resist layer on a predetermined region of a surface of the insulation resin layer; a step of forming a first metal layer with a plating method on a region of the surface of the insulation resin layer except the region where the first resist layer is formed; a step of forming a via hole by laser machining using the first metal layer as a mask to remove at least a predetermined region of the insulation resin layer and to expose part of a conductor layer formed on one side of the insulation resin layer that faces the core wiring board; a step of forming a second resist layer on a region of a surface of the first metal layer except the region around the via hole; a step of forming a second metal layer with a plating method on a region of the surface of the first metal layer except the region where the second resist layer is formed and on an inner surface of the via hole; a step of removing the second resist layer; a step of forming a third resist layer on a predetermined region of the surface of the first metal layer and on a surface of the second metal layer; and a step of forming a second conductor circuit pattern by etching the first metal layer using the third resist layer as a mask.

In the method of fabricating a printed wiring board according to this one aspect, as described above, the step of forming the first resist layer on the predetermined region of the surface of the insulation resin layer, and the step of forming the first metal layer with the plating method on the region of the surface of the insulation resin layer except the region where the first resist layer is formed are employed. Usually, a resist layer can be formed minutely, and the side surfaces of the resist layer can be formed substantially vertically. Accordingly, according to the above structure, the inner diameter of the part (the part where the resist layer is formed) of the first metal layer where the via hole is to be formed can be made sufficiently small, and it is possible to prevent the part (the part where the resist layer is formed) from having a mortar shape in cross section. As a result of this, it is possible to form a minute via hole with high accuracy by laser machining using the first metal layer as the mask.

In the method of fabricating a printed wiring board according to the above one aspect, as described above, the thickness of the first metal layer can be made sufficiently small by forming the first metal layer with the plating method compared with a case where the first metal layer is formed of, for example, metal foil. Thus, in forming the second conductor circuit pattern by etching the first metal layer, it is possible to form the second conductor circuit pattern easily and minutely.

In the method of fabricating a printed wiring board according to this one aspect, as described above, the step of forming the second metal layer with the plating method on the region of the surface of the first metal layer except the region where the second resist layer is formed and on the inner surface of the via hole. Thus, because the first metal layer that forms the second conductor circuit pattern, and the second metal layer that is formed on the inner surface of the via hole can be formed of separate layers, it is possible to form the second conductor circuit pattern easily and minutely securing a thickness of the second metal layer that is formed on the inner surface of the via hole.

In the method of fabricating a printed wiring board according to the above one aspect, it is preferable that at least an electroless plating method is used in the step of forming the first metal layer. According to this method, it is possible to easily form the first metal layer on the surface of the insulation resin layer.

In this case, it is preferable that both electroless plating method and electrolytic plating method are used in the step of forming the first metal layer. According to this method, it is possible to easily shorten the plating time required for forming the first metal layer.

In the method of fabricating a printed wiring board according to the above one aspect, it is preferable that a step of removing the first resist layer is further employed before the step of forming the via hole. According to this method, it is possible to easily remove the insulation resin layer to form the via hole by laser machining using the first metal layer as a mask.

In the method of fabricating a printed wiring board according to the above one aspect, it is preferable that the step of forming the via hole includes one step of removing the first resist layer and a predetermined region of the insulation resin layer by laser machining with the first metal layer used as a mask. According to this method, it is possible to curb increase in the number of steps for forming the via hole.

In the method of fabricating a printed wiring board according to the above one aspect, it is preferable that at least an electroless plating method is used in the step of forming the second metal layer. According to this method, it is possible to easily form the second metal layer on the region of the surface of the first metal layer except the region where the second resist layer is formed and on the inner surface of the via hole.

In this case, it is preferable that both electroless plating method and electrolytic plating method are used in the step of forming the second metal layer. According to this method, it is possible to easily shorten the plating time when forming the second metal layer to a large thickness.

In the method of fabricating a printed wiring board according to the above one aspect, it is preferable that the step of forming the via hole includes a step of forming the via hole by exposing part of the first conductor circuit pattern with laser machining. According to this method, it is possible to easily connect electrically the first conductor circuit pattern and the first metal layer (the second conductor circuit pattern) with each other through the via hole.

In the method of fabricating a printed wiring board according to the above one aspect, it is preferable that a step of roughening and dehydrating the surface of the insulation resin layer is further employed before the step of forming the first metal layer. By forming the first metal layer after the surface of the insulation resin layer is roughened, it is possible to raise the bonding strength between the first metal layer and the insulation resin layer. Thus, in the step of forming the via hole, even if the first metal layer is subjected to a large thermal stress due to laser light or pressurized by a machining gas, it is possible to prevent the first metal layer from peeling off the insulation resin layer. In a case where the bonding strength between the first metal layer and the insulation resin layer is small, if the first metal layer is subjected to a large thermal stress due to laser light or pressurized by a machining gas in the step of forming the via hole, there is a possibility that the first metal layer peels off the insulation resin layer in the part around the via hole. Because the bonding strength between the first metal layer and the insulation resin layer can be raised, it is possible to increase the peeling-off strength of the first metal layer. Besides, by forming the first metal layer after dehydrating the insulation resin layer, it is possible to prevent the first metal layer from peeling off the insulation resin layer because of the curbed vaporization (expansion) of water absorbed in the insulation resin layer even if the insulation resin layer is heated by laser light in the step of forming the via hole.

### BRIEF DESCRIPTION OF THE DRAWINGS

FIG. 1 is a sectional view showing a structure of a printed wiring board according to an embodiment of the present invention.

FIG. 2 is a sectional view showing a structure of a core wiring board of the printed wiring board according to the embodiment of the present invention shown in FIG. 1.

FIG. 3 is a sectional view to explain a method of fabricating the printed wiring board according to the embodiment of the present invention shown in FIG. 1.

FIG. 4 is a sectional view to explain a method of fabricating the printed wiring board according to the embodiment of the present invention shown in FIG. 1.

FIG. 5 is a sectional view to explain a method of fabricating the printed wiring board according to the embodiment of the present invention shown in FIG. 1.

FIG. 6 is a sectional view to explain a method of fabricating the printed wiring board according to the embodiment of the present invention shown in FIG. 1.

FIG. 7 is a sectional view to explain a method of fabricating the printed wiring board according to the embodiment of the present invention shown in FIG. 1.

FIG. 8 is a sectional view to explain a method of fabricating the printed wiring board according to the embodiment of the present invention shown in FIG. 1.

FIG. 9 is a sectional view to explain a method of fabricating the printed wiring board according to the embodiment of the present invention shown in FIG. 1.

FIG. 10 is a sectional view to explain a method of fabricating the printed wiring board according to the embodiment of the present invention shown in FIG. 1.

FIG. 11 is a sectional view to explain a method of fabricating the printed wiring board according to the embodiment of the present invention shown in FIG. 1.

FIG. 12 is a sectional view showing a structure of a printed wiring board as a conventional example in which a via hole is formed.

FIG. 13 is a sectional view showing a structure of a core wiring board of the printed wiring board as the conventional example shown in FIG. 12.

FIG. 14 is a sectional view to explain a method of fabricating the printed wiring board as the conventional example shown in FIG. 12.

FIG. 15 is a sectional view to explain a method of fabricating the printed wiring board as the conventional example shown in FIG. 12.

FIG. 16 is a sectional view to explain a method of fabricating the printed wiring board as the conventional example shown in FIG. 12.

FIG. 17 is a sectional view to explain a method of fabricating the printed wiring board as the conventional example shown in FIG. 12.

FIG. 18 is a sectional view to explain a method of fabricating the printed wiring board as the conventional example shown in FIG. 12.

### DETAILED DESCRIPTION OF PREFERRED EMBODIMENTS

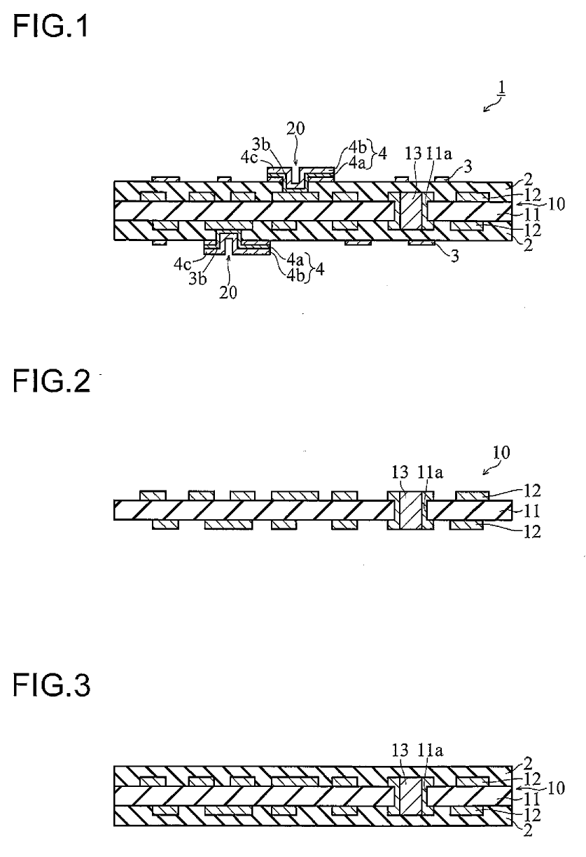

First, a structure of a printed wiring board according to an embodiment of the present invention is explained with reference to FIGS. 1 and 2.

A printed wiring board 1 according to an embodiment of the present invention is used for electronic devices and the like. As shown in FIG. 1, the printed wiring board 1 is composed of a core wiring board 10 that includes conductor circuit patterns 12 formed on both surfaces (upper and lower surfaces) of an insulation layer 11, insulation resin layers 2 formed on both surfaces (upper and lower surfaces) of the core wiring board 10, conductor circuit patterns 3 formed on surfaces of the insulation resin layers 2, and plated layers 4 formed on predetermined regions of surfaces of the conductor circuit patterns 3. The conductor circuit pattern 12 is examples of a “first conductor circuit pattern” and a “conductor layer” in the present invention. The conductor circuit pattern 3 is an example of a “second conductor circuit pattern” in the present invention, and the plated layer 4 is an example of a “second metal layer” in the present invention.

The insulation layer 11 of the core wiring board 10 is formed of, for example, a glass-fiber reinforced resin material. The core wiring board 10 may be formed of another material such as a polyimide resin and the like besides the glass-fiber reinforced resin material. The conductor circuit pattern 12 is formed of copper foil and the like.

As shown in FIG. 2, a through hole 11a is formed through the insulation layer 11. The conductor circuit pattern 12 on the upper surface of the insulation layer 11, and the conductor circuit pattern 12 on the lower surface of the insulation layer 11 are electrically connected with each other via the through hole 11a. A filling material 13 formed of a conductor, a dielectric or the like is filled in the conductor circuit pattern 12 at the through hole 11a. However, the filling material 13 may not be filled in the conductor circuit pattern 12 at the through hole 11a.

Here, in the present embodiment, as shown in FIG. 1, the conductor circuit patterns 3 include copper plated layers formed on surfaces (upper and lower surfaces) of the insulation resin layers 2, and are formed to a thickness of, for example, about 0.1 μm to several micrometers.

Via holes 20 are formed on predetermined regions of the printed wiring board 1, and the plated layer 4 is so formed as to cover the inner surface (surface of the conductor circuit pattern 12 included) of the via hole 20. Thus, the conductor circuit pattern 3 formed on the outer side of the insulation resin layer 2 and the conductor circuit pattern 12 formed on the inner side of the insulation resin layer 2 are electrically connected with each other.

In the present embodiment, the plated layer 4 is formed on a surface of part of the conductor circuit pattern 3 that is located around the via hole 20.

The plated layer 4 includes an electroless plated layer 4a that is formed on a predetermined region of the surface of the conductor circuit pattern 3 and on the inner surface of the via hole 20, and an electrolytic plated layer 4b formed on a portion of the surface of the electroless plated layer 4a.

The electroless plated layer 4a is formed to a thickness of, for example, about 0.05 μm to several micrometers, and the electrolytic plated layer 4b is formed to a thickness of, for example, about 5 μm to about 50 μm. The thicknesses of the electroless plated layer 4a and the electrolytic plated layer 4b are determined by taking performance such as current capacity, impedance and the like necessary for the printed wiring board 1 into account. Depending on circumstances, the electroless plated layer 4a may be formed to a necessary thickness without forming the electrolytic plated layer 4b.

A part 4c of the plated layer 4 that is located on a portion of the surface of the conductor circuit pattern 3 functions as a via-hole land.

Next, a method of fabricating the printed wiring board according to an embodiment of the present invention is explained with reference to FIGS. 1 to 11.

First, as shown in FIG. 2, the core wiring board 10 that includes the conductor circuit patterns 12 formed on both surfaces of the insulation layer 11 is prepared. This core wiring board 10 is produced by applying conventionally known methods such as through-hole machining, panel plating, pattern etching and the like to a commercially available double-side copper-clad laminate that is formed by laminating and bonding the copper foil (the conductor circuit patterns 12) on both surfaces of the glass-fiber reinforced epoxy resin material (the insulation layer 11).

In the present embodiment, as shown in FIG. 3, the insulation resin layers 2 are so formed on both surfaces of the core wiring board 10 as to cover the conductor circuit patterns 12. Specifically, in the present embodiment, because the glass epoxy resin is used to form the insulation layer 11 (the core wiring board 10), commercially available prepregs formed of a semicured glass epoxy resin are disposed on both surfaces of the core wiring board 10, heated and pressurized to be bonded to both surfaces of the core wiring board 10. It may also be possible to bond resin materials formed of a cured glass epoxy resin to both surfaces of the core wiring board 10 with adhesives disposed therebetween. Besides, it is also possible to bond a prepreg or a resin material formed of another material.

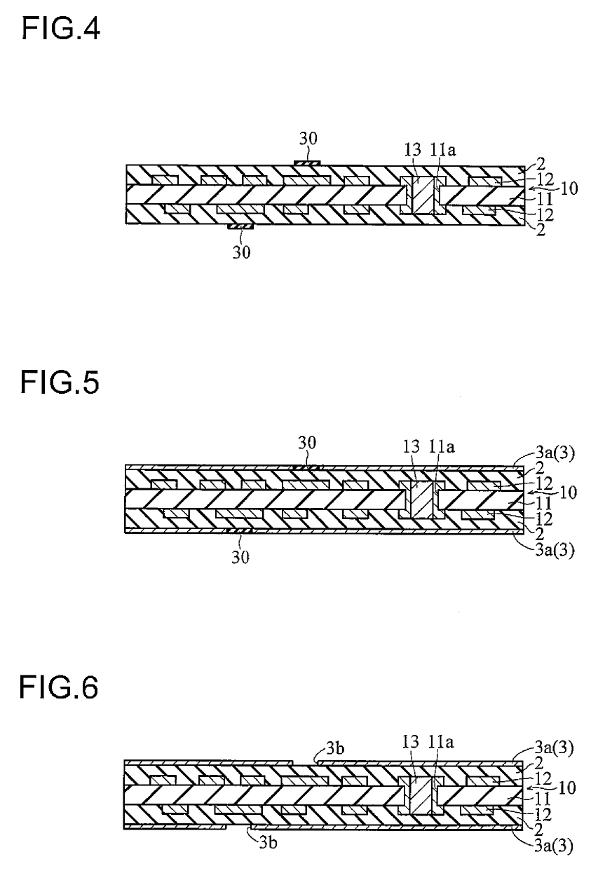

Then, in the present embodiment, as shown in FIG. 4, the plating resist layer 30 is formed on the predetermined region (the region where the via hole 20 of the insulation resin layer 2 is to be formed) of the surface of the insulation resin layer 2. Usually, when forming a plating resist layer, it is possible to form the side surface of the plating resist layer substantially perpendicularly to the core wiring board, and also the side surface of the plating resist layer 30 in the present embodiment is formed substantially perpendicularly to the core wiring board 10 (the insulation layer 11). The plating resist layer 30 is an example of a “first resist layer” in the present invention.

Besides, the plating resist layer 30 can be formed of, for example, a light-sensitive resin and can also be formed into a minute shape on a desired position with an accuracy to several micrometers or fewer. The plating resist layer 30 can also be formed of, for example, a plating resist that includes an acryl-denatured novolak-epoxy resin which is commercially available for electroless copper plating.

And, in the present embodiment, the surface of the insulation resin layer 2 is roughened by using a chromic-acid surface-roughening agent that is commercially available, and then, neutralized and washed. And, the insulation resin layer 2 and the core wiring board 10 are dehydrated by performing heat treatment (drying treatment) at a temperature of about 120° C. for 1 hour or longer.

Then, in the present embodiment as shown in FIG. 5, a copper plated layer 3a having a thickness of about 0.1 μm to several micrometers is formed with an electroless plating method on a region of the surface of the insulation resin layer 2 except the region where the plating resist layer 30 is formed. Here, an electroless copper plating bath that contains, for example, copper sulfate, EDTA (ethylenedianidetetraacetic acid), NaOH and other additives is used. The copper plated layer 3a is an example of a “first metal layer” in the present invention.

Depending on laser machining conditions described later, after the copper plated layer 3a is formed with the electroless plating method, a copper layer and other metal layers may be formed on the copper plated layer 3a. Here, electrolytic plating may be performed using the copper plated layer 3a as an electricity-feeding layer. As described above, if the electrolytic plating is performed after the electroless plating is carried out, when forming the layers (the copper plated layer 3a, the copper layer and the other metal layers) that serve as the masks at the time of laser machining described later, it is possible to shorten the plating time.

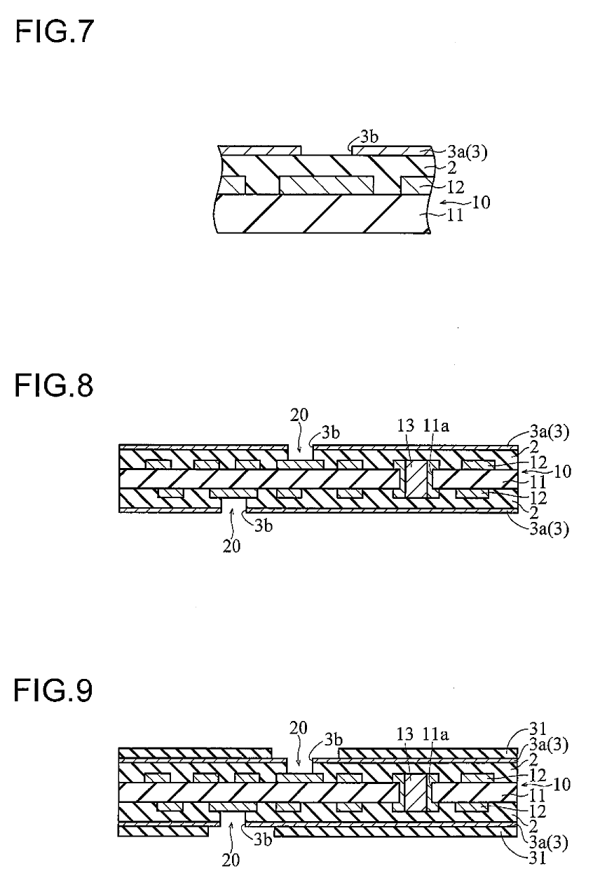

And, the plating resist layer 30 is peeled off by using a plating-resist peeling solution. Thus, as shown in FIG. 6, a small-diameter hole portion 3b is formed with high accuracy through the region of the copper plated layer 3a where the via hole 20 is to be formed. As shown in FIG. 7, the sectional shape (the inner surface) of the hole portion 3b is formed substantially perpendicularly to the core wiring board 10.

Next, as shown in FIG. 8, the predetermined region (the region under the hole portion 3b of the copper plated layer 3a) of the insulation resin layer 2 is removed by laser machining using a carbon dioxide gas laser with the copper plated layer 3a used as a mask until part of the conductor circuit pattern 12 is exposed. Thus, the via hole 20 is formed on the printed wiring board 1.

The laser used here is a laser that is suitable for the machining of the insulation resin layer 2. For example, in a case where a polyimide resin is used for the insulation resin layer 2, it is preferable to use a YAG laser.

Then, in the present embodiment, as shown in FIG. 9, a plating resist layer 31 is formed on a predetermined region (a region except the region around the via hole 20) of the surface of the copper plated layer 3a. The plating resist layer 31 is an example of a “second resist layer” in the present invention.

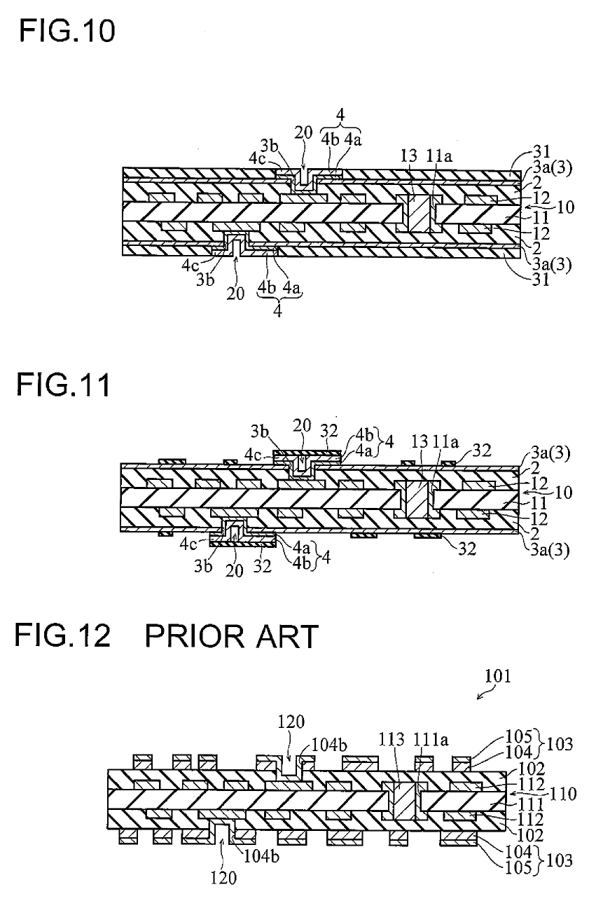

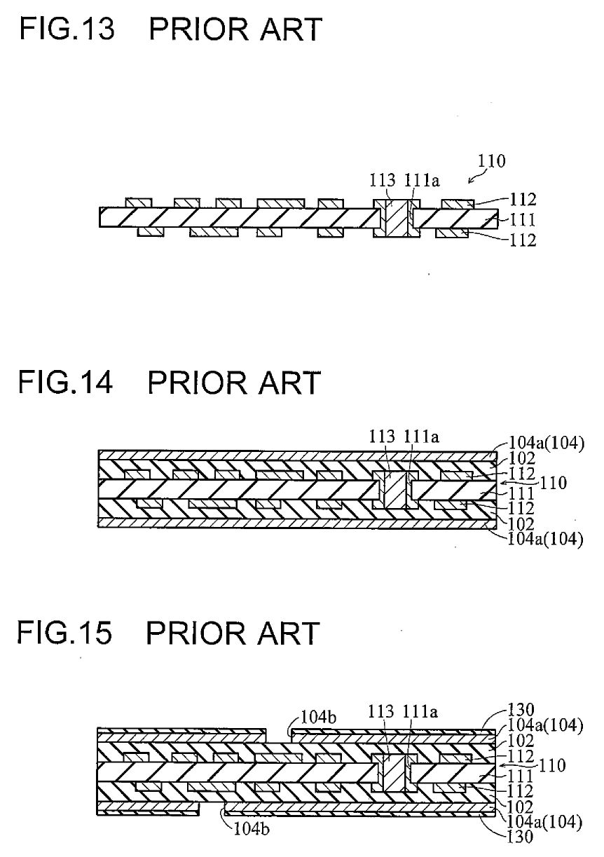

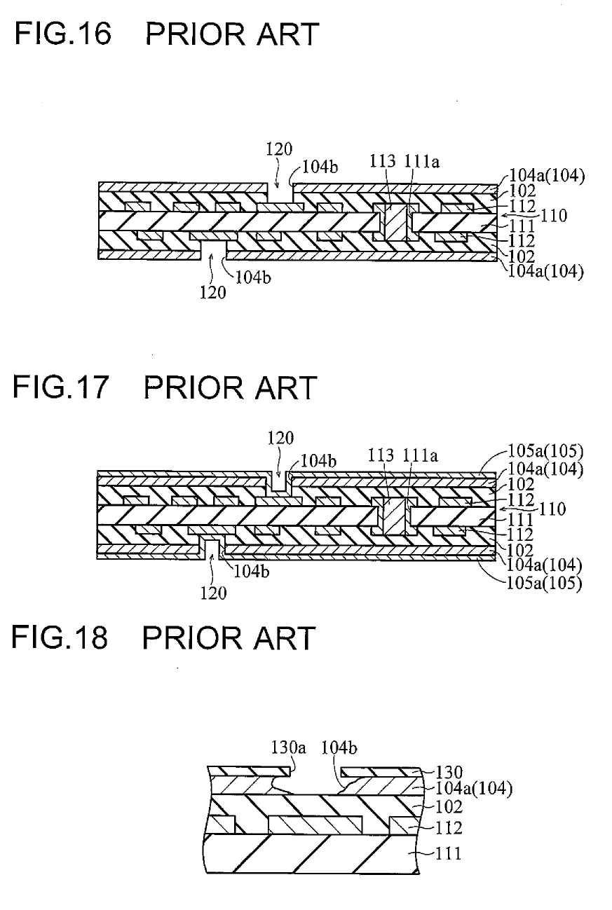

And, the inside of the via hole 20 is cleaned and washed, and pre-plating treatment is performed. Then, as shown in FIG. 10, the plated layer 4 is formed on the region of the surface of the copper plated layer 3a except the region where the plating resist layer 31 is formed.

Specifically, the electroless plated layer 4a having a thickness of, for example, about 0.05 μm to several micrometers is formed with the electroless plating method on the region of the surface of the copper plated layer 3a except the region where the plating resist layer 31 is formed. Here, the electroless plated layer 4a is also formed on the inner surface (surface of the conductor circuit pattern 12 included) of the via hole 20.

In addition, the electrolytic plated layer 4b having a thickness of, for example, about 5 μm to about 50 μm is formed with the electrolytic plating method on the surface of the electroless plated layer 4. Here, the copper plated layer 3a and the electroless plated layer 4a are used as electricity-feeding layers.

Thus, the plated layer 4 including the part 4c that functions as a via hole land is formed.

Then, the plating resist layer 31 is peeled off by using a plated-resist peeling solution.

And, in the present embodiment, an etching resist layer 32 is formed on predetermined regions of the surface of the plated layer 4 and of the surface of the copper plated layer 3a. Thus, the structure shown in FIG. 11 is obtained. The etching resist layer 32 is an example of a “third resist layer” in the present invention.

Then, part of the copper plated layer 3a is etched by using the etching resist layer 32 as a mask to form the conductor circuit pattern 3. Here, in the present embodiment, because the layer (the copper plated layer 3a) to be etched is formed of copper, an etching solution containing cupric chloride or ferric chloride is used. And, the etching resist layer 32 is removed.

As described above, the printed wiring board 1 according to the embodiment of the present invention shown in FIG. 1 is fabricated.

In the present invention, as described above, the step of forming the plating resist layer 30 on the predetermined region of the surface of the insulation resin layer 2, and the step of forming the copper plated layer 3a by using the electroless plating method on the region of the surface of the insulation resin layer 2 except the region where the plating resist layer 30 is formed are employed. Thus, the plating resist layer 30 can be minutely formed, and the side surfaces of the plating resist layer 30 can be formed substantially vertically, thereby not only the inner diameter of the part (the hole portion 3b) of the copper plated layer 3a where the via hole 20 is to be formed can be made sufficiently small but also the sectional shape of the part (the hole portion 3b) where the via hole 20 is to be formed can be prevented from having a mortar shape. Consequently, it is possible to form the minute via hole 20 with high accuracy by laser machining using the copper plated layer 3a as the mask.

Besides, in the present embodiment, it is possible to make the thickness of the copper plated layer 3a sufficiently small by forming the copper plated layer 3a using the electroless plating method compared with a case where, for example, metal foil is used to form the copper plated layer 3a. Thus, when forming the conductor circuit pattern 3, it is possible to form easily and minutely the conductor circuit pattern 3 by etching the copper plated layer 3a.

In the present embodiment, as described above, the copper plated layer 3a (the conductor circuit pattern 3) and the plated layer 4 formed on the inner surface of the via hole 20 are formed of separate layers, thereby the conductor circuit pattern 3 can be formed easily and minutely securing the desired thickness of the plated layer 4 formed on the inner surface of the via hole 20.

In the present embodiment, as described above, it is possible to increase the bonding strength between the copper plated layer 3a and the insulation resin layer 2 by forming the copper plated layer 3a after the surface of the insulation resin layer 2 is roughened. Thus, in the step of forming the via hole 20, even if the copper plated layer 3a is subjected to a large thermal stress due to laser light or pressurized by a machining gas, it is possible to prevent the copper plated layer 3a from peeling off the insulation resin layer 2. In a case where the bonding strength between the copper plated layer 3a and the insulation resin layer 2 is small, if the copper plated layer 3a is subjected to a large thermal stress due to laser light or pressurized by a machining gas in the step of forming the via hole 20, there is a possibility that the copper plated layer 3a peels off the insulation resin layer 2 in the part around the via hole 20. Because the bonding strength between the copper plated layer 3a and the insulation resin layer 2 can be raised, it is possible to increase the peeling-off strength of the copper plated layer 3a. Besides, by forming the copper plated layer 3a after dehydrating the insulation resin layer 2, it is possible to prevent the copper plated layer 3a from peeling off the insulation resin layer 2 because of the curbed vaporization (expansion) of water absorbed in the insulation resin layer 2 even if the insulation resin layer 2 is heated by laser light in the step of forming the via hole 20.

It must be thought that the embodiment disclosed above is an example in all respects and is not limiting. The scope of the present invention is not indicated by the above explanation of the embodiment but by the claims, and all modifications within the scope of the claims and the equivalent meaning and scope are included.

For example, in the embodiment described above, the core wiring board that includes the conductor circuit patters formed on both surfaces of the insulation layer is used. However, the present invention is not limited to this structure, and a core wiring board that includes the conduction circuit pattern formed, for example, on only the upper surface of the insulation layer.

In the embodiment described above, the insulation resin layers and the copper plated layers (the copper plated patterns) are formed on both surfaces of the core wiring board. However, the present invention is not limited to this structure, and the insulation resin layer and the copper plated layer (the copper plated pattern) may be formed on, for example, only the upper surface of the core wiring board.

In the present embodiment described above, the copper plated layers (the copper plated patterns) are formed on both surfaces of the core wiring board, that is, one layer on one surface and the other layer on the other surface of the core wiring board with the insulation resin layer interposed therebetween. However, the present invention is not limited to this structure, and a plurality of insulation resin layers and a plurality of copper plated layers (copper plated patterns) may be laminated alternately on both surfaces of the core wiring board.

In the embodiment described above, the via hole is so formed as to connect the conductor circuit pattern of the core wiring board and the copper plated layer (the copper plated pattern). However, the present invention is not limited to this structure, and is applicable to a case where a via hole is so formed as to connect a copper plated layer (a copper plated pattern) formed on the inner surface (which faces the core wiring board) of a predetermined insulation resin layer and a copper plated layer (a copper plated pattern) formed on the outer surface of the predetermined insulation resin layer if a plurality of insulation resin layers and a plurality of copper plated layers (copper plated patterns) are formed alternately on both surfaces of the core wiring board as described above.

In the present embodiment described above, the plating resist layer is peeled off before laser machining is performed using the copper plated layer as the mask. However, the present invention is not limited to this method, and laser machining may be performed using the copper plated layer as the mask without peeling off the plating resist layer. In other words, the plating resist layer and the predetermined region of the insulation resin layer may be removed in one step by laser machining using the copper plated layer as the mask. In this case, it is possible to curb increase in the number of steps for forming the via hole.

In the present embodiment described above, the surface of the insulation resin layer is roughened before the copper plated layer is formed on the surface of the insulation resin layer. However, the present invention is not limited to this method, and the surface of the insulation resin layer may not be roughened.

In the present embodiment described above, the insulation resin layer and the core wiring board are dehydrated before the copper plated layer is formed on the surface of the insulation resin layer. However, the present invention is not limited to this method, and the insulation resin layer and the core wiring board may not be dehydrated.

In the present embodiment described above, the copper plated layer (the copper plated pattern) is formed on the surface of the insulation resin layer. However, the present invention is not limited to this structure, and a plated layer (a plated pattern) formed of a metal other than copper may be formed on the surface of the insulation resin layer.

In the present embodiment described above, the core wiring board on which the conductor circuit pattern is formed of copper foil is used. However, the present invention is not limited to this structure, and a core wiring board on which the conductor circuit pattern is formed of metal foil made of a metal other than copper or a plated layer may be used.

In the present embodiment described above, the core wiring board through which a through hole is formed is used. However, the present invention is not limited to this structure, and a core wiring board through which no through hole is formed may be used.

What is claimed is:

1. A method of fabricating a printed wiring board, comprising:
a step of preparing a core wiring board composed of a first conductor circuit pattern that is formed on at least one surface of an insulation layer;
a step of forming an insulation resin layer on at least one surface side of the core wiring board to cover the first conductor circuit pattern;
a step of forming a first resist layer on a predetermined region of a surface of the insulation resin layer;
a step of forming a first metal layer with a plating method on a region of the surface of the insulation resin layer except the region where the first resist layer is formed;
a step of forming a via hole by laser machining using the first metal layer as a mask to remove at least a predetermined region of the insulation resin layer and to expose part of a conductor layer formed on one side of the insulation resin layer that faces the core wiring board;
a step of forming a second resist layer on a region of a surface of the first metal layer except the region around the via hole;
a step of forming a second metal layer with a plating method on a region of the surface of the first metal layer except the region where the second resist layer is formed and on an inner surface of the via hole;
a step of removing the second resist layer;
a step of forming a third resist layer on a predetermined region of the surface of the first metal layer and on a surface of the second metal layer; and
a step of forming a second conductor circuit pattern by etching the first metal layer using the third resist layer as a mask.

2. The method of fabricating a printed wiring board according to claim 1, wherein at least an electroless plating method is used in the step of forming the first metal layer.

3. The method of fabricating a printed wiring board according to claim 2, wherein both electroless plating method and electrolytic plating method are used in the step of forming the first metal layer.

4. The method of fabricating a printed wiring board according to claim 1, further comprising a step of removing the first resist layer before the step of forming the via hole.

5. The method of fabricating a printed wiring board according to claim 1, wherein the step of forming the via hole includes one step of removing the first resist layer and a predetermined region of the insulation resin layer by laser machining with the first metal layer used as a mask.

6. The method of fabricating a printed wiring board according to claim 1, wherein at least an electroless plating method is used in the step of forming the second metal layer.

7. The method of fabricating a printed wiring board according to claim 6, wherein both electroless plating method and electrolytic plating method are used in the step of forming the second metal layer.

8. The method of fabricating a printed wiring board according to claim 1, wherein the step of forming the via hole includes a step of forming the via hole by laser machining to expose part of the first conductor circuit pattern.

9. The method of fabricating a printed wiring board according to claim 1, further comprising a step of roughening and dehydrating the surface of the insulation resin layer before the step of forming the first metal layer.
